(19) United States
(12) Patent Application Publication
(10) Pub. No.: US 2025/0024038 A1
(43) Pub. Date: Jan. 16, 2025

(54) METHOD AND APPARATUS FOR VIDEO CODING USING ADAPTIVE MULTIPLE TRANSFORM SELECTION

(71) Applicants: HYUNDAI MOTOR COMPANY, SEOUL (KR); KIA CORPORATION, SEOUL (KR); EWHA UNIVERSITY - INDUSTRY COLLABORATION FOUNDATION, SEOUL (KR)

(72) Inventors: Je Won KANG, Seoul (KR); Jin HEO, Yongin-si (KR); Seung Wook PARK, Yongin-si (KR)

(21) Appl. No.: 18/900,038

(22) Filed: Sep. 27, 2024

Related U.S. Application Data
(63) Continuation of application No. PCT/KR2023/003214, filed on Mar. 9, 2023.

(30) Foreign Application Priority Data
Mar. 28, 2022 (KR) 10-2022-0037971
Mar. 7, 2023 (KR) 10-2023-0030020

(51) Int. Cl. H04N 19/12; H04N 19/124; H04N 19/159; H04N 19/176; H04N 19/60

(52) U.S. Cl. CPC H04N 19/12; H04N 19/124; H04N 19/159; H04N 19/176; H04N 19/60

(57) ABSTRACT

A method and an apparatus are disclosed for video using adaptive multiple transform selection. In the disclosed embodiments, a video decoding device obtains a multiple-transform-selection index and inverse-quantized residual signals of the current block from a bitstream. The video decoding device composes a plurality of multiple-transform-selection groups for the current block, and selects a multiple-transform-selection group from the multiple-transform-selection groups. The video decoding device derives a transform kernel from the multiple-transform-selection group by using the multiple-transform-selection index. The video decoding device generates inverse-transformed residual signals by inversely transforming the inverse-quantized residual signals by using the derived transform kernel.

### CROSS-REFERENCE TO RELATED APPLICATIONS

This application is a continuation of International Application No. PCT/KR2023/003214 filed on Mar. 9, 2023, which claims priority to and the benefit of Korean Patent Application No. 10-2022-0037971 filed on Mar. 28, 2022, and Korean Patent Application No. 10-2023-0030020, filed on Mar. 7, 2023, the entire contents of each of which are incorporated herein by reference.

### TECHNICAL FIELD

The present disclosure relates to a video coding method and an apparatus using adaptive multiple transform selection.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, as the image size, resolution, and frame rate gradually increase, the amount of data to be encoded also increases. Accordingly, a new compression technique providing higher coding efficiency and an improved image enhancement effect than existing compression techniques is required. In transforming the residual signals of the current block, there is a need for a technique that efficiently utilizes multiple transforms.

### SUMMARY

The present disclosure seeks to provide a video coding method and an apparatus that perform multiple transform selection (MTS) when a residual block of the current block is transformed to increase video coding efficiency and enhance video quality. The video coding method and the apparatus adaptively utilize multiple transform kernels based on features of the residual signals.

At least one aspect of the present disclosure provides a method performed by a video decoding device for decoding a current block. The method includes obtaining a multiple-transform-selection index from a bitstream and obtaining inverse-quantized residual signals of the current block from the bitstream. The method also includes composing a plurality of multiple-transform-selection groups for the current block. Here, each of multiple-transform-selection groups comprises one or more transforms. The method also includes selecting a multiple-transform-selection group from the multiple-transform-selection groups. The method further includes deriving a transform kernel from the multiple-transform-selection group by using the multiple-transform-selection index. The method also includes generating inverse-transformed residual signals by inversely transforming the inverse-quantized residual signals by using the transform kernel.

Another aspect of the present disclosure provides a method performed by a video encoding device for encoding a current block. The method includes obtaining residual signals of the current block. The method also includes composing a plurality of multiple-transform-selection groups for the current block. Here, each of the multiple-transform-selection groups comprises one or more transforms. The method also includes selecting a multiple-transform-selection group from the multiple-transform-selection groups. The method also includes generating transformed residual signals by transforming the residual signals by using transform kernels included in the multiple-transform-selection group. The method also includes determining a multiple-transform-selection index that indicates an optimal transform kernel among the transform kernels.

Yet another aspect of the present disclosure provides a computer-readable recording medium storing a bitstream generated by a video encoding method. The video encoding method includes obtaining residual signals of a current block. The video encoding method also includes composing a plurality of multiple-transform-selection groups for the current block. Here, each of the multiple-transform-selection groups comprises one or more transforms. The video encoding method also includes selecting a multiple-transform-selection group from the multiple-transform-selection groups. The video encoding method also includes generating transformed residual signals by transforming the residual signals by using transform kernels included in the multiple-transform-selection group. The video encoding method also includes determining a multiple-transform-selection index that indicates an optimal transform kernel among the transform kernels.

As described above, the present disclosure provides a video coding method and an apparatus that adaptively utilize multiple transform kernels based on features of the residual signals in performing the multiple transform selection when a residual block of the current block is transformed. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a partition type of a subblock transform (SBT).

FIGS. 7A and 7B are diagrams illustrating the subblock partitioning of the current block.

FIG. 8 is a flowchart of a method performed by a video encoding device for encoding the current block, according to at least one embodiment of the present disclosure.

FIG. 9 is a flowchart of a method performed by a video decoding device for decoding the current block, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

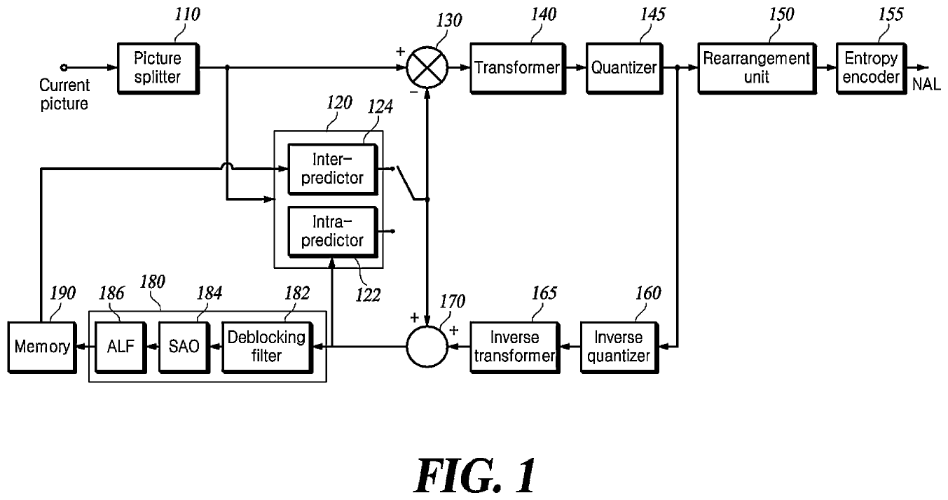

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

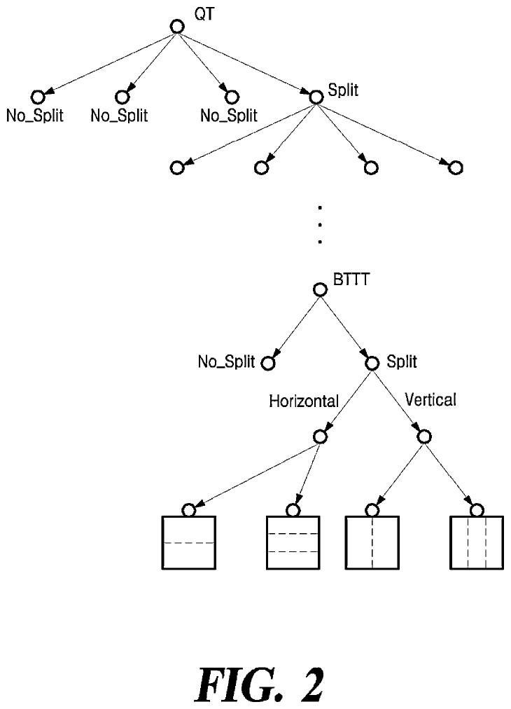

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

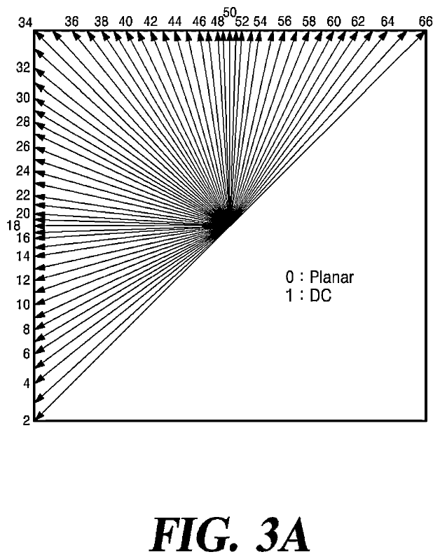

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

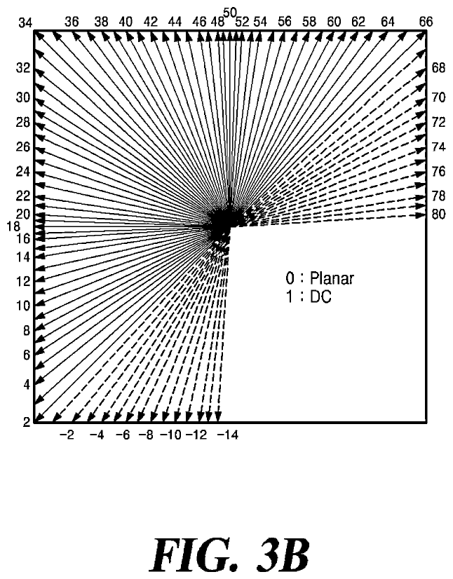

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, a vertical scan of scanning a 2D coefficient array in a vertical, or column direction and a horizontal scan of scanning a 2D block type coefficient in a horizontal, or row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, e.g., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

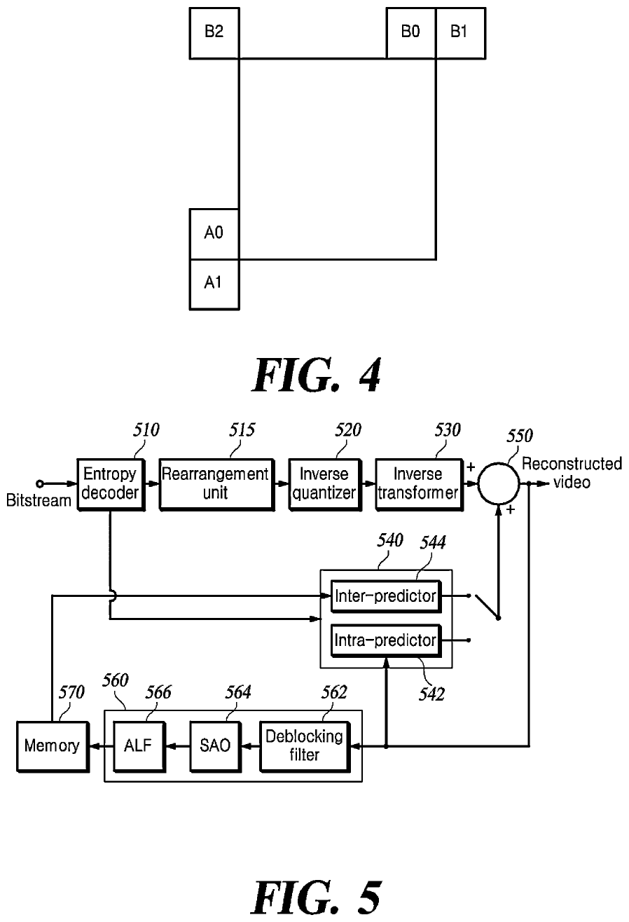

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that adaptively utilize multiple transform kernels based on features of the residual signals in performing multiple transform selection when a residual block of the current block is transformed.

The following embodiments may be performed by the transformer 140 and the inverse transformer 165 in the video encoding device. The following embodiments may also be performed by the inverse transformer 530 in the video decoding device.

The video encoding device in the transform/inverse transform of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the inverse transform of the current block.

In the following description, the term “target block” may be used interchangeably with the current block or coding unit (CU). The term “target block” may refer to some region of the coding unit.

Further, the value of one flag being true indicates when the flag is set to 1. Additionally, the value of one flag being false indicates when the flag is set to 0.

### I. Transform Techniques

As described above, for efficient video compression, quantization or scaling may be further applied to the residual signals that are remnants after prediction by various prediction techniques. In this case, based on the significance of the perceptual visual information inherent in the residual signals, a transform technique may be applied to cluster the residual signals according to their frequency components, and then scaling may be performed. However, for non-natural signals such as screen contents, this frequency-based transform may be inefficient. In such cases, the transform technique may be omitted and scaling may be performed only, or encoding/decoding may be performed without applying scaling.

In HEVC (High Efficiency Video Coding), the transform blocks (TB) have sizes of 4×4, 8×8, 16×16, and 32×32, and may or may not be transformed. If the transform is skipped, a bit-shift may be applied in place of the transform technique. In HEVC, the transform may be skipped for a TB of 4×4. Further, depending on additional flags, the transform may be skipped for other sizes of TBs.

In HEVC, if the transform_skip_rotation_enabled_flag is set to 1, the residual signals in the block that skips the transform may be rotated 180 degrees. In addition, the scan order is also reversed, as symmetry is needed when scanning the residual signals.

When the transform is applied in HEVC, discrete cosine transform-II (DCT-II) is used as a transform kernel (or transform type) for transforming the residual signals. However, multiple transform selection (MTS) may be used to apply a more appropriate transform technique based on variations in residual signal features. MTS determines the optimal type of one or two of multiple transform types and then transforms the block according to the determined transform type. For example, in VVC (Versatile Video Coding), besides DCT-II, two other transform types, DCT-VIII and discrete sine transform-VII (DST-VII), are added, as shown in Table 1, to allow the residual signals to be transformed in different ways.

TABLE 1

| Transform Type | Basis function Tᵢ(j), i, j = 0, 1, . . . , N-1 |
|---|---|
| DCT-II | $\begin{matrix}{T}_{i} ( j ) = {ω}_{0} \cdot \sqrt{\frac{2}{N}} \cdot cos ( \frac{π \cdot i \cdot ( 2 j + 1 )}{2 N} ) \\ where , {ω}_{0} = \{ \begin{matrix}\sqrt{\frac{2}{N}} & i = 0 \\ 1 & i \neq 0\end{matrix}\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

Here, the basis functions form a transform matrix that defines each transform type. Hereinafter, DCT-II, DCT-VIII, and DST-VII are used interchangeably with DCT2, DCT8, and DST7, respectively.

Meanwhile, the flag that determines whether MTS is enabled or disabled may be controlled on a block-by-block basis. In addition, the use of MTS may be controlled by using an enable flag at a higher SPS level (Sequence Parameter Set level).

When MTS is enabled at the SPS, a CU-level flag may be indicated to tell whether MTS is applied. Here, MTS may be applied to the luma component. The CU-level flag may be expressed if both the width and height of the TB are less than or equal to 32 pixels, and the coded block flag (CBF) indicating whether any of the transform coefficient levels have non-zero values is true.

If the CU-level flag is zero, DCT2 is utilized as the kernels in both horizontal and vertical directions. On the other hand, if the CU-level flag is non-zero, MTS is applied. MTS may be utilized in two ways: explicit MTS and implicit MTS.

In an explicit MTS, the kernel used for the TB is explicitly transmitted. Typically, the index of the transform kernel may be transmitted. For example, mts_idx, the index of the kernel, may be defined as shown in Table 2.

TABLE 2

| mts_idx | 0 | 1 | 2 | 3 | 4 |
|---|---|---|---|---|---|
| trTypeHor | 0 | 1 | 2 | 1 | 2 |
| trTypeVer | 0 | 1 | 1 | 2 | 2 |

Here, trTypeHor and trType Ver represent the transform type in the horizontal direction and the transform type in the vertical direction. Additionally, 0 indicates DCT2, 1 indicates DST7, and 2 indicates DCT8.

On the other hand, in an implicit MTS, the transform type may be determined implicitly without explicitly signaling the MTS, e.g., in the case of an intra-block. In VVC, the transform types in the horizontal and vertical directions may be implicitly determined, as shown in Equation 1.

$$trTypeHor = ( nTbW >= 4 \&\& nTbW <= 16 ) ? DST 7 : DCT 2 \\ trTypeVer = ( nTbH >= 4 \&\& nTbH <= 16 ) ? DST 7 : DCT 2 \qquad [ Equation 1 ]$$

Here, nTbW and nTbH denote the horizontal and vertical lengths of the transform block, respectively.

In one example, when a particular encoding technique is applied, explicit MTS or implicit MTS may be applied. For example, in Matrix-weighted Intra Prediction (MIP), an explicit intra MTS may be used. In the Intra Sub-Partitions (ISP) mode, an implicit intra MTS is used, with DST7 or DCT2 as the transform type.

On the one hand, if the transform block contains at least one or more non-DC coefficients, mts_idx is signaled. This means that if the position of the last valid coefficient in the scanning order is greater than zero, mts_idx is signaled. On the other hand, if the transform block contains only one non-DC coefficient, signaling of mts_idx is omitted, and it is inferred that mts_idx=0, and DCT2 is applied as the transform kernel.

The first bin of mts_idx that is signaled, indicates whether mts_idx is greater than zero. If mts_idx is greater than zero, i.e., if mts_idx indicates one of 1 to 4, an additional two bits of fixed length code is signaled to indicate the signaled mts_idx among the four candidates.

Meanwhile, in the next generation of technology, the Enhanced Compression Model (ECM) software, the number and types of MTS kernels are increased, adding DST7, DCT8, DCT5, DST4, DST1, and identity transform.

In addition, in ECM, a Non-separable Primary Transform (NSPT) based on the Karhunen-Loeve Transform (KLT) may be used to replace the VVC's primary transform kernel, DCT-II, when the block has a certain size.

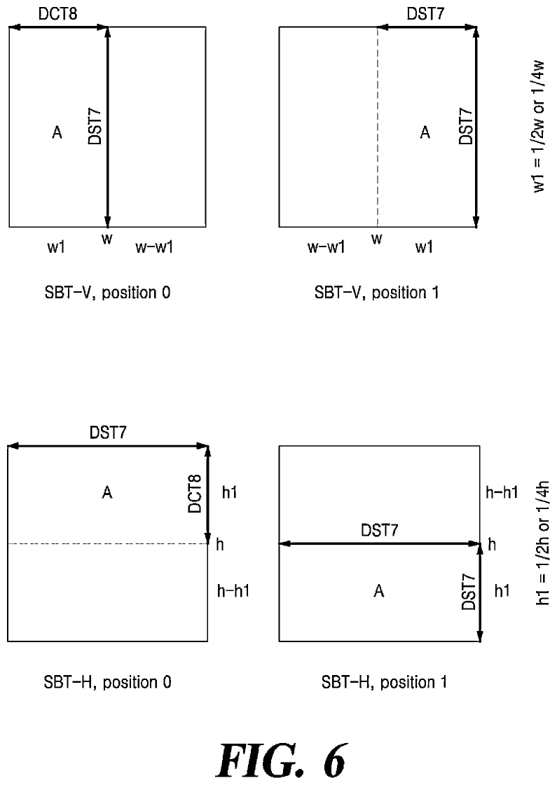

FIG. 6 is a diagram illustrating a partition type of a subblock transform (SBT).

As a transform technique, SBT performs the transform on a subblock basis by partitioning the CU into smaller blocks when the inter-predicted block is encoded. At this time, information on the SBT type and SBT location of the block may be signaled, as illustrated in FIG. 6. In SBT-V (or, SBT-H), the width (or height) of the Transform Unit (TU) may be equal to half or a quarter of the width (or height) of the CU. This may result in 2:2 partitioning or 1:3/3:1 partitioning.

Depending on the type of SBT, horizontal and vertical transforms may be differently applied implicitly. As illustrated in FIG. 6, the horizontal and vertical transforms may be applied for each SBT position. For example, the horizontal and vertical transforms for SBT-V position 0 are DCT8 and DST7, respectively. Additionally, if the width or height of the TU is greater than 32, the horizontal and vertical transforms are set to DCT2. In the example of FIG. 6, block A represents a subblock that is subject to the transform.

### II. Intra Prediction and Intra Sub-Partitions (ISP)

In the VVC technique, the intra-prediction modes of the luma block, as illustrated in FIGS. 3A and 3B, have subdivided directional modes (−14 to 80) further to non-directional modes (planar and DC). Based on these prediction modes, several techniques exist to improve the coding efficiency of intra prediction. ISP techniques sub-partition the current block into smaller blocks of equal size and then arrange the intra-prediction mode to be shared across the subblocks, but ISP techniques may apply a transform to each subblock. The sub-partitioning of the blocks may be in either a horizontal or vertical direction.

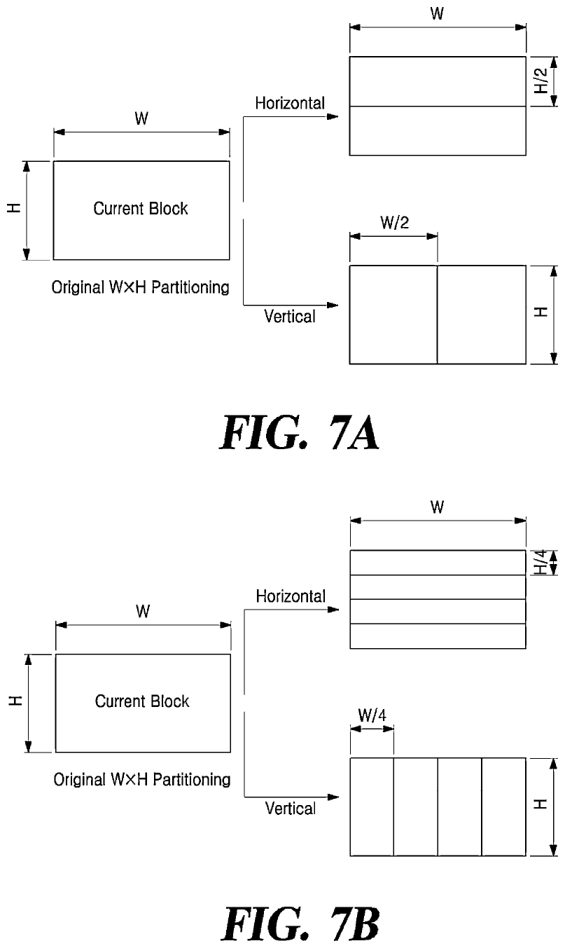

In the following description, the large block before being sub-partitioned is referred to as the current block, and each of the sub-partitioned smaller blocks is represented by a subblock, as shown in the examples of FIGS. 7A and 7B. In ISP mode, the current block may be partitioned horizontally (ISP_HOR_SPLIT) or vertically (ISP_VER_SPLIT), as shown in the examples of FIG. 7A and FIG. 7B. Hereinafter, ISP_HOR_SPLIT is used in conjunction with horizontal partitioning, and ISP_VER_SPLIT is used in conjunction with vertical partitioning.

When the current block is partitioned in the horizontal or vertical direction, the application of ISP may be limited by the size of the current block at the time of sub-partitioning to prevent sub-partitioning of too small blocks. If the current block is 4×4, ISP is not applied. As illustrated in FIG. 7A, a block with a size of 4×8 or 8×4 may be partitioned into two subblocks with the same shape and size, which is called a Half_Split. Additionally, a block of any other size may be partitioned into four subblocks of the same shape and size, as illustrated in FIG. 7B, which is called a Quarter_Split.

The video encoding device encodes each subblock sequentially. At this time, each subblock shares the same intra-prediction information. In the intra prediction for encoding each subblock, the video encoding device may utilize the reconstructed pixels in the earlier encoded subblock as the predicted pixel values for the subsequent subblocks to increase the compression efficiency.

The following describes the behavior between ISP mode and other encoding techniques of VVC.

If the index of the Multiple Reference Line (MRL) is non-zero, i.e., if the pixels on the line immediately adjacent to the predicted block are not referenced, the ISP mode is inferred to be zero and is not enabled. Therefore, no information related to the ISP mode is transmitted.

Regarding the size of the transform coefficient group of entropy coding, when ISP is applied, the entropy coding subblock has sizes equal to 16 samples for all possible cases, as shown in Table 3.

TABLE 3

| Block Size | Coefficient group size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

With regard to CBF (coded block flag) coding, when ISP mode is applied, at least one of the subblocks may be inferred to have a non-zero CBF. Thus, if the total number of subblocks is n and the front n-1 subblocks generate a zero CBF, the last subblock is inferred to be a non-zero CBF.

Regarding the generation of the Most Probable Mode list (MPM list) of intra prediction, the list is modified to exclude the DC mode and to prioritize the horizontal intra-prediction mode in the case of horizontal partitioning of the ISP. Additionally, in the case of vertical partitioning of the ISP, the list may be modified to prioritize intra-prediction modes in the vertical direction.

Regarding the transform kernel, DCT2 is used as the kernel when transforming blocks larger than 16 for subblocks in ISP mode.

With regard to the Position Dependent Intra Prediction Combination (PDPC), when the CU is using ISP mode, the PDPC filter is not applied to the subblocks.

On the other hand, if the CU is using ISP mode, the CU-level flag indicating whether MTS is to be applied is implicitly set to zero. In this case, the transform type for ISP mode is fixed and selected, which depends on the intra-prediction mode, the processing order of the subblocks, and the size of the subblocks. As described above, when trTypeHor and trTypeVer denote the transform types in the horizontal and vertical directions, the transform types for a subblock of size w×h may be selected as follows.

For w=1 or h=1, no horizontal or vertical transform is applied, respectively. For w=2 or w>32, trTypeHor is set to DCT-II. For h=2 or h>32, trType Ver is set to DCT-II. For the remaining cases, trTypeHor and trType Ver may be selected as shown in Table 4.

TABLE 4

| Intra mode | trTypeHor | trTypeVer |
|---|---|---|
| Planar | DST-VII | DST-VII |
| Ang. 31, 32, 34, 36, 37 | | |
| DC | DCT-II | DCT-II |
| Ang. 33, 35 | | |
| Ang. 2, 4, 6 . . . 28, 30 | DST-VII | DCT-II |
| Ang. 39, 41, 43 . . . 63, 65 | | |
| Ang. 3, 5, 7 . . . 27, 29 | DCT-II | DST-VII |
| Ang. 38, 40, 42 . . . 64, 66 | | |

The following embodiments are described about the video decoding device, but may also be performed by the video encoding device as described above.

### III. Adaptive Multiple Transform Selection

As described above, a conventional MTS invariably uses four candidate transform types regardless of the nature of the residual signals in a block, i.e., four pairs of horizontal and vertical transform types indicated by mts_idx. When the residual signals for transform are small in size and few in number, the coding efficiency can be improved by reducing the number of MTS candidates to reduce the overhead for MTS signaling. Further, when the residual signals are large in size and numerous in number, the coding efficiency can be improved by utilizing a larger number of MTS candidates to cope with the diversity of more complex signals.

In providing different MTS groups according to the features of the residual signals, a method of composing an MTS group composed of different kernels, and conditions under which the MTS group is applied in the encoding process are described below.

### <Implementation 1>Method of Composing MTS Groups

In this implementation, various MTS groups (MTS Group1 to MTS Group4) including one or more transforms (T0 to T4) are composed as shown in Table 5.

TABLE 5

| mts_idx | 0 | 1 | 2 | 3 | 4 |
|---|---|---|---|---|---|
| MTS Group 1 | T0 | | | | |
| MTS Group 2 | T0 | T1 | | | |
| MTS Group 3 | T0 | T1 | T2 | | |
| MTS Group 4 | T0 | T1 | T2 | T3 | T4 |

Here, MTS Group 1 uses the default transform, T0. In addition, MTS Groups 2 through 4 are composed of more different transforms. For example, Group 4 includes transforms corresponding to T0 through T4, which may be mapped to mts_idx 0 through 4. The MTS groups shown in Table 5 may be selectively applied under different encoding conditions.

With regard to the application of the MTS groups, TO may be set as the primary transform and assigned to mts_idx-0. For example, the transform kernel of the TO transform may be DCT2 or NSPT (Non-separable Primary Transform). Hereinafter, TX (e.g., X is 0 to 4) is represented by the transform, and DCT2, DCT8, DST7, and the like are represented by the transform kernel.

As shown in Table 5, one or more transforms may be added sequentially as the index of the group increases, and mts_idx may be mapped accordingly.

In one example, as the index of the group increases, different transforms may be included, or the index may change for the transforms. For example, in Table 5, T3 and T2 of MTS Group 4 may change as shown in Table 6 below.

TABLE 6

| | | | | | |
|---|---|---|---|---|---|
| MTS Group 4 | T0 | T1 | T3 | T2 | T4 |

As another example, even when the index of the group increases, the number of transforms may not increase sequentially, as shown in Table 7, but rather the number of transforms may remain the same but in different arrangements.

TABLE 7

| | | | | | |
|---|---|---|---|---|---|
| mts_idx | 0 | 1 | 2 | 3 | 4 |

| | | | | |
|---|---|---|---|---|
| MTS Group 1 | T0 | | | |
| MTS Group 2 | T0 | T1 | T2 | T3 |
| MTS Group 3 | T0 | T2 | T1 | T3 |
| MTS Group 4 | T0 | T2 | T3 | T4 |

In one example, transforms TO through T4 may be assigned a fixed transform kernel. For example, the transform kernel used by the VVC may be used. For example, TO is DCT2, T1 is DCT8, T2 is DST7, T3 is DCT5, and T4 is the identity transform.

As another example, rather than assigning a fixed transform kernel to the TO through T4 transforms, the transform kernels may be assigned adaptively. For example, information on which transform kernel is mapped to T0 through T4 may be signaled in the SPS, PPS, or slice header (SH) of the video. Accordingly, adaptive MTS groups may be used on a sequence-by-sequence basis. In this case, to be signaled means that the video encoding device and the video decoding device do not transmit all of the kernel coefficients that make up the transform, but rather utilize a predetermined index to transmit those coefficients with the video encoding device and the video decoding device storing the same set of transform kernel coefficients. For example, it is assumed that DCT2 is index 0, DCT8 is index 1, and DST7 is index 2. In this case, when signaling MTS Group 2 in Table 5 as shown in Table 8, the transform kernels DCT2 and DST7 may be used as TO and T1 transforms, respectively.

TABLE 8

| | | |
|---|---|---|
| MTS Group 2 | 0 | 2 |

In this case, TO is always fixed to DCT2, which is the primary transform kernel, and only some remaining transform kernels may be signaled, as shown in Table 9.

TABLE 9

| | |
|---|---|
| MTS Group 2 | 2 |

In one example, instead of transmitting all groups, the transform kernels constituting some of the groups may be fixed and some of the groups may be signaled. For example, while the transform kernels of MTS Groups 1 and 2 are fixed, the video decoding device may set the transform kernels of MTS Groups 3 and 4 by decoding signals signaled on SPS, PPS, or SH, and then use the set transform kernels.

As another example, in addition to adaptively changing the number of transforms constituting a group, information related to the number of MTS groups may be signaled such that the number of MTS groups is also adaptively changed.

In the foregoing examples, the TO through T4 transforms are fixed or adaptively correspond to a single transform kernel regardless of the horizontal and vertical directions, respectively, which, however, does not limit the present disclosure. For example, each transform may be fixed or adaptively corresponding to separate horizontal and vertical transform kernels.

<Implementation 2>Conditions Under which MTS Groups are Applied During the Encoding Process

As described above, when the residual signals are small in magnitude and few in number, the coding efficiency can be improved by reducing the number of MTS candidates to reduce the overhead for MTS signaling. Furthermore, when the residual signals are large in magnitude and there are a large number of the residual signals, the coding efficiency may be improved by utilizing a larger number of MTS candidates to cope with the diversity of the more complex signals. Accordingly, different groups of MTSs may be utilized depending on the following conditions and combinations of one or more conditions.

Hereinafter, all MTS groups determined by the present implementation are based on, but not necessarily limited to, Table 5.

### <Implementation 2-1>Application of MTS Groups Based on Frame (Block) Shape

As an example, different MTS groups are utilized depending on whether the type of frame to be encoded (hereinafter referred to as ‘current frame’) is an intra frame (I-frame) or a predictive/bi-predictive frame (P/B-frame), or a predictive/bi-predictive block. For example, if the current frame is an intra frame, MTS Groups 1, 3, and 4 in Table 5 are used. However, if the current frame is a P/B frame, MTS Groups 1 and 2 in Table 5 may be used. Additionally, for P/B frames, the use of NSPT may be restricted to MTS groups.

Further, different MTS groups are utilized depending on whether the current block is an I block or a P/B block. For example, if the current block is an I block, MTS Groups 1, 3, and 4 in Table 5 are utilized. However, if the current block is a P/B block, MTS Groups 1 and 2 in Table 5 may be used. Additionally, if the current block is the P/B block, the use of NSPT may be restricted to MTS groups.

As another example, one or more MTS grouping tables may be composed and different MTS grouping tables may be used depending on the type of current frame (block). Namely, grouping tables for intra-MTS may be different from those for inter-MTS. For example, Table 5 may be used for Intra MTS and Table 10 may be used for Inter MTS.

TABLE 10

| | | | | | |
|---|---|---|---|---|---|
| mts_idx | 0 | 1 | 2 | 3 | 4 |

| | | |
|---|---|---|
| MTS Group 1 | T0 | |
| MTS Group 2 | T0 | T1 |
| MTS Group 3 | T0 | T2 |
| MTS Group 4 | T0 | T3 |

### <Implementation 2-2>Application of MTS Groups Based on the Quantization Parameter

Different MTS groups are used depending on the size of the Quantization Parameter (QP) of the current block. For example, if the QP is less than the preset value of 24, MTS Group 4 is used. Additionally, if QP is greater than or equal to 24 and less than 37, MTS Group 3 is used. Additionally, MTS Group 2 may be used if the QP is greater than or equal to 37.

In addition to using different MTS groups based on the size of the QP of the current block, the above conditions may be applied based on the size of the quantization parameter per video frame. Alternatively, the foregoing conditions may be applied depending on the size of the quantization parameter being signaled in units of video sequence. Conclusively, a different MTS group may be used depending on a magnitude of the QP of the current block, a current frame, or a current sequence.

### <Implementation 2-3>Application of MTS Group According to Intra-Prediction Mode

In one example, the MTS group is composed as shown in Table 5 according to the intra-prediction mode of the current block. For example, if the intra-prediction mode is vertical or near vertical, MTS Group 2 is utilized. On the other hand, if the intra-prediction mode is horizontal or near horizontal, MTS Group 3 is used. Additionally, MTS Group 1 may be utilized if it is DC or Planar mode.

### <Implementation 2-4>Application of MTS Group Based on the Size of the Block

In one example, the MTS groups are composed according to the size of the current block as shown in Table 5. For example, if either the width or height of the block is greater than or equal to 32, MTS Group 1 is utilized. Additionally, if either the width or height of the block is less than or equal to 8, MTS Group 3 is used. In other cases, MTS Group 2 may be utilized.

When an MTS group is composed based on the size of the current block, transform kernels that do not support the size of a particular block are excluded from that group. For example, if the width and height of a block are both greater than or equal to 16, NSPT may not be applied. Therefore, if an MTS group is composed based on the size of a block, that MTS group may not include NSPT.

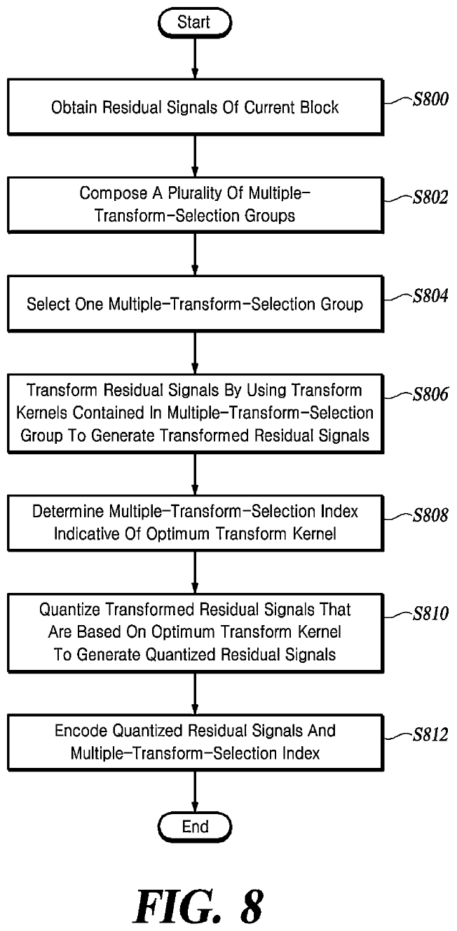

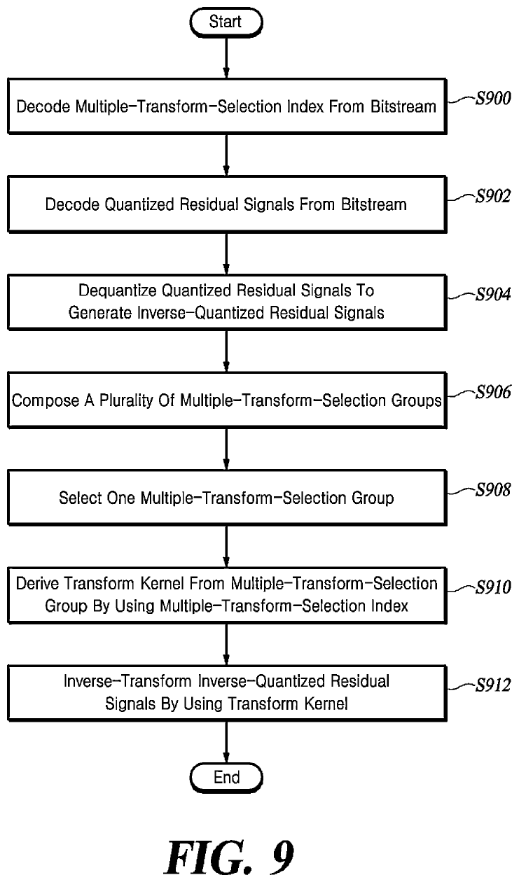

Referring now to FIGS. 8 and 9, a video encoding/decoding method utilizing adaptive multiple transform selection is described.

FIG. 8 is a flowchart of a method performed by a video encoding device for encoding the current block, according to at least one embodiment of the present disclosure.

The video encoding device obtains residual signals of the current block (S800). The video encoding device may generate the residual signals by subtracting the current block's predictor from the current block.

The video encoding device composes a plurality of multiple-transform-selection groups for the current block (S802). Each of the multiple-transform-selection groups includes one or more transforms.

The video encoding device may compose a plurality of multiple multiple-transform-selection groups according to Implementation 1.

In one example, each of the multiple-transform-selection groups may include one or more transforms, inclusive of a primary transform. In this case, the one or more transforms may correspond to a fixed transform kernel.

As another example, each of the multiple-transform-selection groups may include at least one adaptive transform kernel. In this case, the video encoding device may determine at least one index indicating the at least one adaptive transform kernel.

As another example, each of the multiple-transform-selection groups may include a fixed transform kernel for the primary transform and may further include at least one or more adaptive transform kernels. At this time, the video encoding device may determine at least one index indicating the at least one or more adaptive transform kernels.

The video encoding device selects one multiple-transform-selection group from the plurality of multiple-transform-selection groups (S804). The video encoding device may select the one multiple-transform-selection group according to Implementation 2.

The video encoding device transforms the residual signals by using the transform kernels included in the multiple-transform-selection group to generate the transformed residual signals (S806). For example, in terms of rate-distortion optimization, the video encoding device may determine an optimal transform kernel among the transform kernels included in the multiple-transform-selection group.

The video encoding device determines a multiple-transform-selection index that indicates the optimal transform kernel among the transform kernels (S808).

The video encoding device quantizes the transformed residual signals based on the optimal transform kernel to generate quantized residual signals (S810). The video encoding device quantizes the transformed residual signals based on the optimal transform kernel among the transform kernel-specific transformed residual signals.

The video encoding device encodes the quantized residual signals and the multiple-transform-selection index (S812).

FIG. 9 is a flowchart of a method performed by a video decoding device for decoding the current block, according to at least one embodiment of the present disclosure.

The video decoding device decodes the multiple-transform-selection index from the bitstream (S900).

The video decoding device decodes the quantized residual signals from the bitstream (S902).

The video decoding device inverse-quantizes the quantized residual signals to generate inverse-quantized residual signals (S904).

The video decoding device composes a plurality of multiple-transform-selection groups for the current block (S906). Here, each of the multiple-transform-selection groups includes one or more transforms.

The video decoding device may compose a plurality of multiple-transform-selection groups according to Implementation 1.

In one example, each of the multiple-transform-selection groups may include one or more transforms, inclusive of a primary transform. In this case, the one or more transforms may correspond to a fixed transform kernel.

As another example, each of the multiple-transform-selection groups may include at least one or more adaptive transform kernels. In this case, the video decoding device may decode at least one index indicating the at least one or more transform kernels from the bitstream.

As yet another example, each of the multiple-transform-selection groups may include a fixed transform kernel for a primary transform and may further include at least one or more adaptive transform kernels. In this case, the video decoding device may decode at least one index indicating the at least one or more adaptive transform kernels from the bitstream.

The video decoding device selects one multiple-transform-selection group from the plurality of multiple-transform-selection groups (S908). The video decoding device may select one multiple-transform-selection group according to Implementation 2.

The video decoding device derives a transform kernel from the multiple-transform-selection group by using the multiple-transform-selection index (S910).

The video decoding device inverse-transforms the inverse-quantized residual signals by using the transform kernel to generate the inverse-transformed residual signals (S912). The video decoding device may then generate a reconstructed block by summing the inverse transformed residual signals and the predictor of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

What is claimed is:

1. A method performed by a video decoding device for decoding a current block, the method comprising:
obtaining a multiple-transform-selection index from a bitstream and obtaining inverse-quantized residual signals of the current block from the bitstream;
composing a plurality of multiple-transform-selection groups for the current block, wherein each of multiple-transform-selection groups comprises one or more transforms;
selecting a multiple-transform-selection group from the multiple-transform-selection groups;
deriving a transform kernel from the multiple-transform-selection group by using the multiple-transform-selection index; and
generating inverse-transformed residual signals by inversely transforming the inverse-quantized residual signals by using the transform kernel.

2. The method of claim 1, wherein obtaining the inverse-quantized residual signals comprises:
decoding quantized residual signals from the bitstream; and
generating the inverse-quantized residual signals inversely quantizing the quantized residual signals.

3. The method of claim 1, wherein each of the multiple-transform-selection groups comprises a primary transform.

4. The method of claim 1, wherein the one or more transforms correspond to a fixed transform kernel.

5. The method of claim 1, wherein each of the multiple-transform-selection groups comprises at least one or more adaptive transform kernels,
wherein composing the multiple-transform-selection groups comprises:
decoding, from the bitstream, at least one index indicating the at least one or more adaptive transform kernels.

6. The method of claim 3, wherein each of the multiple-transform-selection groups comprises a fixed transform kernel for the primary transform, and further comprises at least one or more adaptive transform kernels,
wherein composing the multiple-transform-selection groups comprises:
decoding, from the bitstream, at least one index indicating the at least one or more adaptive transform kernels.

7. The method of claim 1, wherein the multiple-transform-selection groups comprise:
some multiple-transform-selection groups that comprise at least one or more fixed transform kernels; and
other remaining multiple-transform-selection groups that comprise at least one or more adaptive transform kernels.

8. The method of claim 1, wherein selecting the multiple-transform-selection group comprises:
selecting a different multiple-transform-selection group based on whether the current block is an intra block or I block or a predictive/bi-predictive block or P/B block.

9. The method of claim 1, wherein selecting the multiple-transform-selection group comprises:
selecting a different multiple-transform-selection group based on a magnitude of a quantization parameter of the current block, a current frame, or a current sequence.

10. The method of claim 1, wherein selecting the multiple-transform-selection group comprises:
selecting a different multiple-transform-selection group based on an intra-prediction mode of the current block.

11. The method of claim 1, wherein selecting the multiple-transform-selection group comprises:
selecting a different multiple-transform-selection group based on a width, height, or size of the current block.

12. A method performed by a video encoding device for encoding a current block, the method comprising:
obtaining residual signals of the current block;
composing a plurality of multiple-transform-selection groups for the current block, wherein each of the multiple-transform-selection groups comprises one or more transforms;
selecting a multiple-transform-selection group from the multiple-transform-selection groups;
generating transformed residual signals by transforming the residual signals by using transform kernels included in the multiple-transform-selection group; and
determining a multiple-transform-selection index that indicates an optimal transform kernel among the transform kernels.

13. The method of claim 12, further comprising:
generating quantized residual signals by quantizing transformed residual signals that are based on the optimal transform kernel; and
encoding the quantized residual signals and the multiple-transform-selection index.

14. A computer-readable recording medium storing a bitstream generated by a video encoding method, the video encoding method comprising:
obtaining residual signals of a current block;
composing a plurality of multiple-transform-selection groups for the current block, wherein each of the multiple-transform-selection groups comprises one or more transforms;
selecting a multiple-transform-selection group from the multiple-transform-selection groups;
generating transformed residual signals by transforming the residual signals by using transform kernels included in the multiple-transform-selection group; and
determining a multiple-transform-selection index that indicates an optimal transform kernel among the transform kernels.
